(19) United States
(12) Patent Application Publication
(10) Pub. No.: US 2011/0159449 A1
(43) Pub. Date: Jun. 30, 2011

(54) Integrated Material Cooler and Heat Recovery Exchanger Apparatus and Process

(75) Inventor: John S. Salmento, Nazareth, PA (US)

(73) Assignee: FLSMIDTH A/S, Valby (DK)

(21) Appl. No.: 12/650,622

(22) Filed: Dec. 31, 2009

(51) Int. Cl. F27B 9/12; F01K 25/00; F27B 9/30

(52) U.S. Cl. 432/14; 60/650; 432/61

(57) ABSTRACT

A method of cooling a substance heat treated in a material processing plant in which the substance is cooled in a cooling apparatus to a temperature that is about 25% to about 55% of the temperature at which the partially cooled substance was when it entered the cooling apparatus. Heated gas is recycled from the cooling apparatus to at least one other process within the plant and the partially cooled substance is delivered from the cooler to a cogeneration system in which the substance is further cooled and the heat removed from the substance is used to generate power.

### FIELD OF THE INVENTION

This invention relates broadly to material processing plants in which particulate material is heat treated in a kiln or similar equipment and is thereafter passed to a material cooler. This invention is particularly applicable to cement and lime manufacturing facilities.

### BACKGROUND OF THE INVENTION

In a cement manufacturing plant cement raw meal is precalcined and then calcined to cement clinker in the sintering zone of a rotary kiln. The cement clinker is thereafter directed to a clinker cooler wherein it is cooler prior to further processing. The clinker cooler's primary function, therefore, is to quench the hot clinker as it discharges from the kiln. Additionally, the hot gases exiting the clinker cooler are recovered by the kiln hood and tertiary air duct and utilized as “super heated” secondary air for combustion in the kiln and tertiary air for use in the precalciner that is upstream, based on material flow, from the kiln. A portion of the hot gases can also be used to dry the raw materials entering a cement plant's raw mill. This system of recovering cooler exhaust air forms a very important heat recovery system contributing greatly to the overall energy efficiency and productivity of the modern cement plant.

The temperature of the clinker leaving the rotary kiln is about 1400° C. and between about 80-140° C. when discharged from cooler. The cooling air directed to the upper or front, i.e. recuperative, end of cooler is heated to a temperature from 750-1300° C., and this hot air is recycled back into the production line, normally into the kiln and calciner of the pyroprocessing tower via the so-called tertiary air duct. Typically, the heat lost by the clinker in the lower, or non-recuprative, end of the cooler, when it cools from about 400-700° C. to below about 80-140° C. is not recovered or is recovered via comparatively inefficient co-gen systems.

It would therefore be advantageous to have a method and an apparatus to recover such heat to thereby make the cement manufacturing facility, or any plant that utilizes a kiln and material cooler, more energy efficient.

### SUMMARY OF THE INVENTION

This invention integrates one or more waste heat recovery heat exchangers in a cogeneration system with a material cooler whose primary purpose is to cool particulate material that was previously heat treated in a high temperature oven. The preferred embodiment of this invention is to incorporate the waste heat recovery economizer, boiler, and superheater of a steam Rankine cycle, Kalina cycle, Organic Rankine, or Brayton cycle after the recuperative section of a material cooler at a cement or lime plant. By placing the heat recovery heat exchanger in the clinker cooler, in the case of a cement plant, to absorb the energy in the clinker instead of, or example, in the cooler vent duct, more energy at a higher quality (i.e. at a higher temperature) is available which can be converted into electricity more efficiently and thereby also increase the electric power generated by 25% to 300%. This invention also improves the economics of a cogeneration system at cement or lime plants without significantly affecting plant layout.

### BRIEF DESCRIPTION OF THE DRAWINGS

FIG. 1 is a schematic flow diagram of a portion of a prior art cement plant.

FIG. 2 is a schematic flow diagram of another prior art cement plant having an internal cogeneration system.

FIG. 3 is a schematic flow diagram of one embodiment of this invention.

FIG. 4 is a schematic flow diagram of another embodiment of this invention.

### DETAILED DESCRIPTION OF THE INVENTION

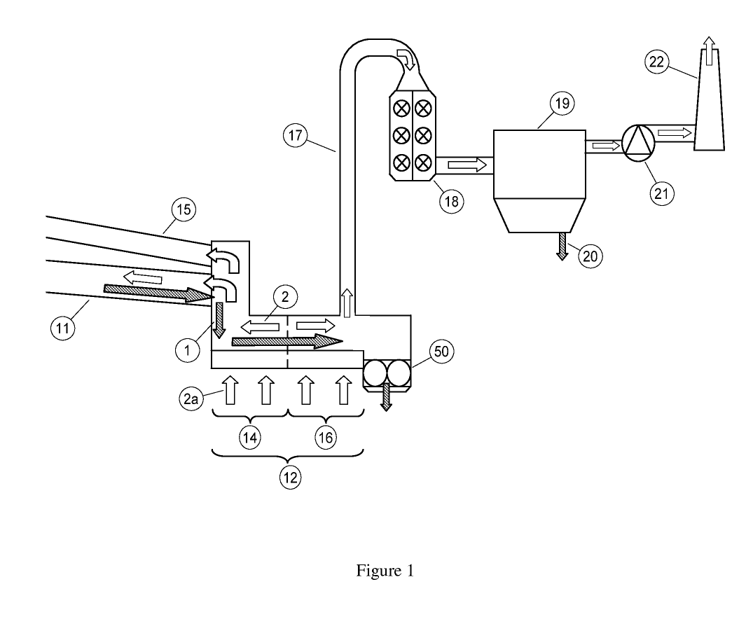

It should be understood at the outset that identical reference numbers on the various drawing sheets, either of the prior art or of the invention, refer to identical elements. The drawings are not necessarily to scale, emphasis instead being placed upon illustrating principles of the invention. With reference to FIGS. 1-4, the movement of clinker through the apparatus of the present invention is depicted by shaded arrows 1, and the movement of cooling air, which subsequently becomes heated during the process, is depicted by non-shaded arrows 2 or 2a.

FIG. 1 shows a portion of a conventional prior art cement plant. Cement raw material, which typically is pre-calcined in a preheating tower (not shown) is first directed to kiln 11 wherein it is calcined to cement clinker. Clinker enters clinker cooler 12 at temperatures between about 1300 to about 1500° C. and exits at approximately 100° C. The clinker is cooled via cooling air, the entry of which into the cooler is represented by arrows 2a. In the recuperative section 14 of the cooler, which is the front end of a conventionally sized cooler, between 60 and 75%, depending upon the efficiency of the cooler, of the energy in the clinker is recovered as secondary air, directed to kiln 11, and tertiary air, directed to the precalciner via duct 15. Recuperative section 14 typically occupies the first ⅓ to ¼ of the length of the cooler.

At the end of the recuperative section the clinker temperature ranges between 400 to 700° C. and therefore contains about 25 to about 55% of its initial thermal energy. The clinker in the non-recuperative section 16 is cooled by air to ˜100° C. The heat transferred to this air in the non-recuperative section exits through the cooler vent duct 17. The cooler vent duct 17 air temperature ranges from ˜250 to 300° C. The air then is drawn by ID fan 21 to, respectively, heat exchanger 18 to cool the air before it enters dust collector 19, from which clinker fines are removed via outlet 20, and finally stack 22, with the air exiting the stack ranges from ˜110 to 150° C. Clinker exiting the cooler can be first sent to crusher 50 prior being directed to a downstream cement mill (not shown).

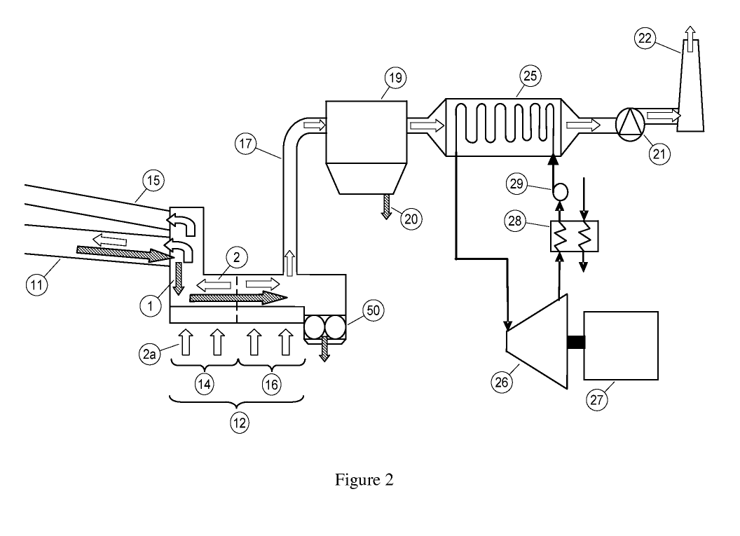

FIG. 2 shows a conventional cement plant with a typical cogeneration system that extracts heat from the cooler vent duct 17. With this system, air is used to remove heat from the clinker in the non-recuperative section and transfer it to the working fluid in the heat recovery steam generator 25, which works in concert with turbine 26, generator 27, condenser 28 and pump 29 as a cogeneration system. In effect, the co-gen system replaces the heat-exchanger in removing heat from the cooler vent duct air, and air exiting stack 22 is still at a temperature that ranges from ˜110 to 150° C.

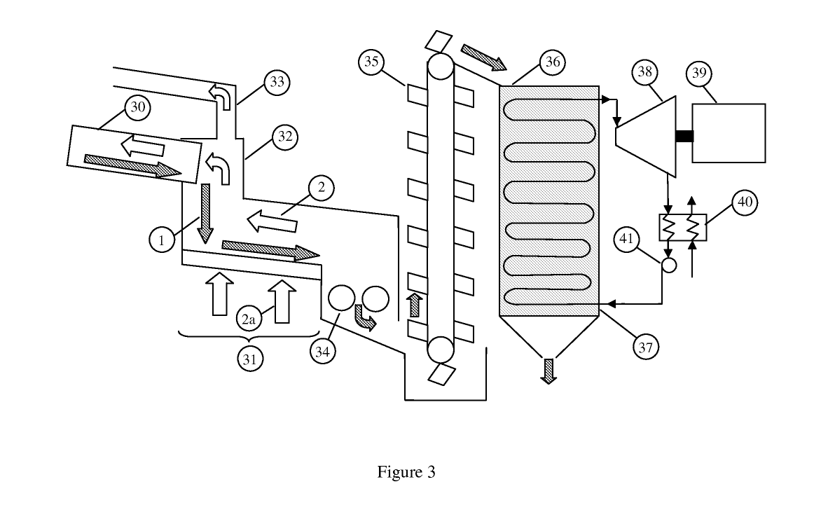

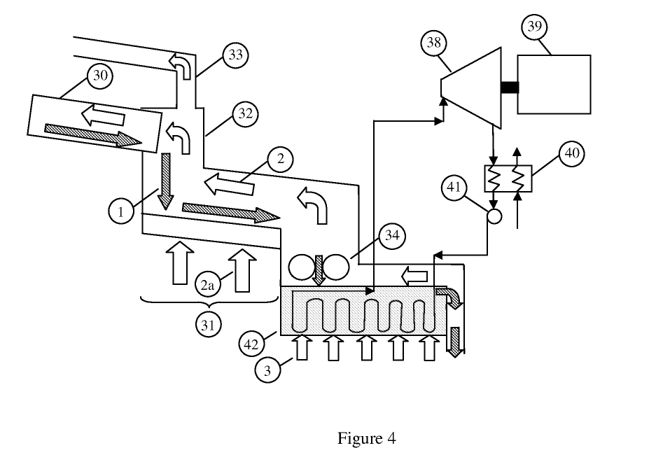

Although FIGS. 3 and 4 are directed to a portion of a cement manufacturing facility, it is understood that the invention may be employed in any industrial process in which particulate material is first heat treated in a oven and thereafter directed to a material cooler.

Calcined raw material is burned into cement clinker in rotary kiln 30. The clinker is thereafter cooled in clinker cooler 31. Super heated “secondary” air is thereafter directed from the cooler into the kiln via kiln hood 32 and heated “tertiary’ air is directed to the precalcining tower (not shown) via duct 33.

It is a feature of the present invention that a shortened clinker cooler 31 then is typically employed is utilized to cool the cement clinker. In a typical cement kilns the material is cooled to below about 80-140° C., which is about 4%-7% of the temperature at which the material enters the cooler, or less. The clinker cooler of the present invention is shortened to the point when the clinker has been cooled to about 25% to about 55%, of the temperature at which the material enters the cooler, or from about 400° C.-700° C. At such a point, the energy saving features of the cooler as exemplified by the transfer of the secondary and tertiary air, have been addressed, but the clinker still contains substantial heat energy that in prior art systems would have been wasted.

In one embodiment of the invention the shortened cooler is approximately the same size as the recuperative section of a normal sized cooler so that secondary and tertiary air are still provided to other areas of the plant and therefore the energy efficiency of the plant remains the same as in prior art systems. In any event, the size of the clinker cooler can be varied to adjust the heat consumption of the cement plant versus the power produced from the downstream cogeneration system to meet the needs of the end user. The downstream cogeneration system is utilized recover much of the heat that would have been removed in the non-recuperative end of the clinker cooler and thereafter lost.

In a less preferred embodiment of the invention, it is possible to reduce the size the conventional clinker cooler so that it contains only a portion of the recuperative section or in fact completely eliminate the conventional clinker cooler which would increase the quantity and quality of the heat going to the cogeneration system at the cost of increasing the heat consumption and decreasing the thermal efficiency of the cement plant.

If desired, a crusher 34 can be placed after the cooler and before (or in between heat recovery heat exchangers 37 when more than one heat exchanger is utilized), to reduce the material's particle size to thereby increase the heat transfer coefficient which will enable the end user to reduce the size of heat exchangers 37 without sacrificing the amount of electricity produced.

The clinker, whether or not a crushing step is employed, is thereafter transferred to bucket elevator (or any other vertical material conveyor) 35 after which it is transferred to the top material inlet of 36 of vertical heat exchanger 37 that is typically, but not always, integral with the cooler, that is, in the same interior environment or within the same overall housing, as the cooler. As indicated, more than one heat exchanger 3′7 may be employed. Gravity moves the clinker vertically downward across the heat recovery heat exchanger(s) as the first step in a cogeneration process which, with regard to the system depicted in FIG. 1, can be either a steam Rankine, Organic Rankine, Kalina cycle, or Brayton cycle. As depicted, the cogeneration system employed is a Rankine cycle in which water is the working fluid and which consists of heat exchanger 37, steam turbine 38, electric generators 39 and condensor 40.

Clinker, at a temperature of approximate 65° C. above ambient, is discharged from the cooler and is directed to the next stage in the process, typically a finish grinding mill (not shown).

The steam output of heat exchanger 37 is connected to an input of one or more steam turbines 38, each of which is coupled by a shaft to one or more electric generators 39. The outputs of steam turbines are connected to the gas inputs of a condensor 40, condensed at constant temperature and pressure to liquid form and reinserted into heat exchanger 37 as part of a closed loop.

In another embodiment shown in FIG. 4, the clinker exiting cooler 31 is crushed to a size that is fluidizable (typically about 0.1 to about 20 mm). The clinker enters a fluidized bed heat recovery heat exchanger 42 and moves essentially horizontally across heat exchanger 42. If necessary a transportation mechanism can be used or the heat exchanger module can be slightly inclined to help move the crushed clinker across the tubes of the fluidized bed. The clinker velocity across the tubes can be adjusted to reduce wear.

The steam generated in the heat exchanger 42 is directed to steam turbine 38 in the same manner as specified above. The main advantages of the configuration of FIG. 4 compared to the configuration in FIG. 3 are the elimination of the vertical conveyor and the higher heat transfer rates by using crushed clinker in the fluidized bed.

The fluidization air, depicted by cross-hatched arrows 3, can be vented through the clinker cooler to become part of the secondary air.

The present invention has advantages over the prior art cement plant having a cogeneration system as depicted in FIG. 2. The first is that there is a lower temperature of the working fluid in the prior art system that is caused by using air to transfer heat from the clinker to the working fluid. In the prior art system the temperature of the working fluid is 100 to 400° C. lower than the temperature of the clinker exiting the recuperative section of the cooler. This is the result in part of having the heat bearing substance (in the depicted examples, cement clinker) in contact with the heat exchanger, rather than having the clinker transfer heat to cooling air which in turn contacts the heat exchanger, which is the case with the prior art. In the present invention, the working fluid (water in the case of a Rankine cogeneration cycle) is only between 30 to 200° C. lower than the temperature of the clinker exiting the recuperative section of the cooler. This increase in working fluid temperature increases the efficiency of the cogeneration between about 20-200%. Another disadvantage of the prior art system is that the air exiting the stack still has between about 5 and 20% of the energy contained in the clinker exiting the recuperative section of the cooler, whereas in the system of the present invention no air exists the stack so this energy can be transferred to the cogeneration system. Finally the present invention permits the elimination of the cooler vent duct, dust collector, ID fan and stack to thereby reduces the capital and operating cost of a cement plant. For example, by eliminating the ID fan the electric power consumption of a cement plant is reduce by ˜3 to 6%.

Although this invention has been described in detail by reference to the drawings, this detail is for illustration only, and it is not to be construed as a limitation upon the invention as described in the appended claims.

What is claimed is:

1. In a material processing plant employing a plurality of material treating processes, a method of cooling a substance comprising
(i) delivering a hot substance from an oven to, and passing said hot substance through, a cooling apparatus in which the hot substance is partially cooled, by cooling apparatus that is subsequently heated in the cooling apparatus, to a temperature that is about 25% to about 55% of the temperature at which the partially cooled substance was when it entered the cooling apparatus;
(ii) recycling heated gas from the cooling apparatus to at least one other process within the plant; and
(iii) delivering the partially cooled substance from the cooler to a cogeneration system in which the substance is further cooled and heat removed from the substance is used to generate power.

2. The method of claim 1 wherein the oven is a rotary kiln and the hot substance is cement clinker that enters the cooling apparatus at a temperature of about 1400° C.

3. The method of claim 2 wherein a first amount of heated air is recycled from the cooler to a precalciner tower located upstream, in the direction of material flow, from the kiln.

4. The method of claim 3 wherein a second amount of heated air is recycled from the cooler to the kiln.

5. The method of claim 1 wherein the cogeneration system is a steam Rankine system that comprises a heat exchanger, a stream turbine, an electrical generator and a condenser.

6. The method of claim 5 wherein the heat exchanger is a vertical heat exchanger.

7. The method of claim 5 wherein the substance is reduced to a fluidizable size after it exits the cooler and prior to it entering the cogeneration system.

8. The method of claim 7 wherein the heat exchanger is a fluid bed heat exchanger.

9. The method of claim 1 wherein the hot substance is lime.

10. An apparatus for cooling hot material and generating power from heat removed from the thus-cooled material comprising
(i) a heating device to heat treat the material;
(ii) a cooling device for partially cooling the heat treated material by contacting said material with a cooling gas that gets heated by said contact, said cooling apparatus having a material inlet, a material outlet, at least one outlet for the heated gas and means to recycle at least some of said heated gas from said at least one outlet into said heating device, wherein the material outlet is located at a point in the cooling device wherein the material exiting the cooling device through the material outlet has been cooled to about 25% to about 55% of the temperature it was at the material inlet; and
(iii) a cogeneration system in which the material exiting the cooling device is further cooled and heat removed from the material is used to generate power.

11. The apparatus of claim 10 wherein the cooling device and the cogeneration system are located within a common housing.

12. The apparatus of claim 10 further comprising a crushing device for crushing said material, said crushing device located intermediate said cooling device and said cogeneration system.

13. The apparatus of claim 10 wherein the heating device is a rotary kiln and the cooling device is a cement clinker cooler.

14. The apparatus of claim 10 further comprising a pre-calciner located upstream, in the direction of material flow, from the kiln and means to recycle at least some of said heated gas from said at least one outlet into said pre-calciner.

15. The apparatus of claim 10 wherein the cogeneration system is a steam Rankine system that comprises a heat exchanger, a stream turbine, an electrical generator and a condenser.

16. The method of claim 10 wherein the heat exchanger is a vertical heat exchanger.

17. The method of claim 10 wherein the heat exchanger is a fluid bed heat exchanger.

18. A method of cooling a hot substance that has been heat treated in a kiln comprising delivering the hot substance to a heat exchanger that is part of a power generating co-generation system to thereby cool the substance.

19. The method of claim 18 wherein the substance is cement clinker.
